(19) United States
(12) Patent Application Publication
(10) Pub. No.: US 2012/0086900 A1
(43) Pub. Date: Apr. 12, 2012

(54) COMMON ELECTRODE PANEL AND METHOD FOR MANUFACTURING THE SAME

(76) Inventors: Se-Hwan YU, Seoul (KR); Sang-Ki Kwak, Asan-si (KR)

(21) Appl. No.: 13/010,712

(22) Filed: Jan. 20, 2011

(30) Foreign Application Priority Data
Oct. 11, 2010 (KR) 10-2010-0098775

(51) Int. Cl. G02F 1/1343; H01J 9/26; H01J 9/00

(52) U.S. Cl. 349/139; 445/24; 445/25

(57) ABSTRACT

A manufacturing method of a liquid crystal display according to an exemplary embodiment includes: forming a thin film transistor array panel including a fan-out region connecting a display area and a peripheral area; forming a common electrode on a substrate; forming a cutout in the common electrode by using a laser; forming a common electrode panel by cutting the substrate; and assembling the thin film transistor array panel and the common electrode panel, wherein the cutout is formed on the edge of the common electrode panel and a portion of the cutout is positioned on the portion corresponding to the fan-out region.

### CROSS-REFERENCE TO RELATED APPLICATION

This application claims priority to and the benefit of Korean Patent Application No. 10-2010-0098775 filed in the Korean Intellectual Property Office on Oct. 11, 2010, the entire contents of which are incorporated herein by reference.

### BACKGROUND

(a) Field of the Invention

The subject matter described herein relates to a manufacturing method of a common electrode panel and liquid crystal display comprising the common electrode panel.

(b) Description of the Related Art

A liquid crystal display is currently one of the most widely used flat panel displays that includes two display panels on which electrodes are formed and a liquid crystal layer is disposed therebetween. The display controls the intensity of transmitted light by rearranging the liquid crystal molecules of the liquid crystal layer by applying a voltage to the electrodes.

The most popular liquid crystal display uses field generating electrodes provided in two display panels in which a plurality of thin film transistors and pixel electrodes are arranged in a matrix (hereinafter referred to as “thin film transistor array panel”), and a common electrode covers the entire surface thereof in the other display panel (hereinafter referred to as “common electrode panel”).

Each display panel is manufactured by forming a thin film pattern of a multi-layered structure to form a plurality of cells including a thin film pattern of the multi-layered structure on a mother glass through a deposition process and a photolithography process, and cutting the mother glass as a unit of the cell.

When the common electrode panel is cut from the mother glass, the common electrode is exposed to material contamination and the detrimental affects of moisture resulting in the formation of corrosion on the common electrode.

The above information disclosed in this Background section is only for enhancement of understanding of the background of the invention and therefore it may contain information that does not form the prior art that is already known in this country to a person of ordinary skill in the art.

### SUMMARY

According to an exemplary embodiment, a cutout of the common electrode is formed at the edge of the common electrode panel and the common electrode is disposed within a sealed space of the display device to prevent material contamination of the common electrode and exposure of the common electrode to the detrimental affects of moisture.

### BRIEF DESCRIPTION OF THE DRAWINGS

FIG. 1 is a top plan view of a mother glass for a common electrode panel according to an exemplary embodiment.

FIG. 2 is a cross-sectional view taken along the line II-II of FIG. 1.

FIG. 3 is a top plan view of a liquid crystal display according to an exemplary embodiment.

FIG. 4 is a cross-sectional view taken along the line IV-IV of FIG. 3.

FIG. 5 is a cross-sectional view taken along the line V-V of FIG. 3.

### DETAILED DESCRIPTION

The subject matter disclosed herein will be described more fully hereinafter with reference to the accompanying drawings, in which exemplary embodiments are shown. As those skilled in the art would realize, the described embodiments may be modified in various ways without departing from the spirit or scope of the claims presented below .

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

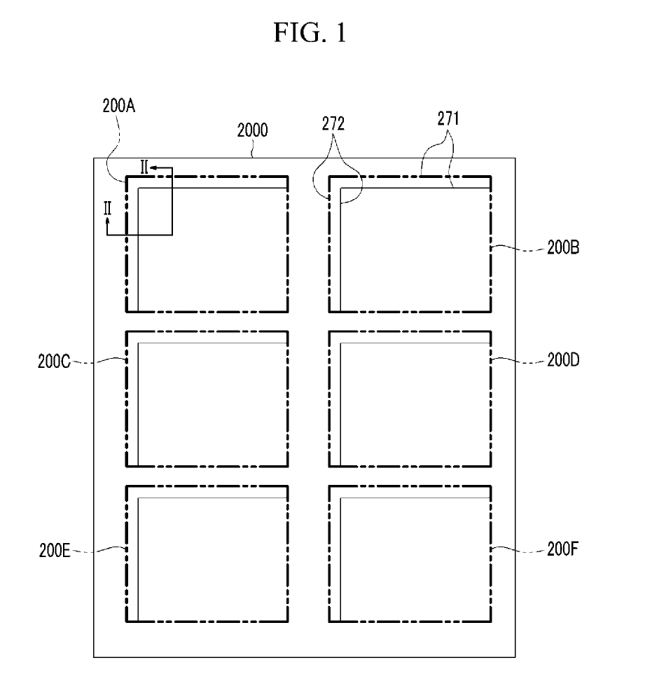

Now, a liquid crystal display according to an exemplary embodiment will be described with reference to FIG. 1 to FIG. 5.

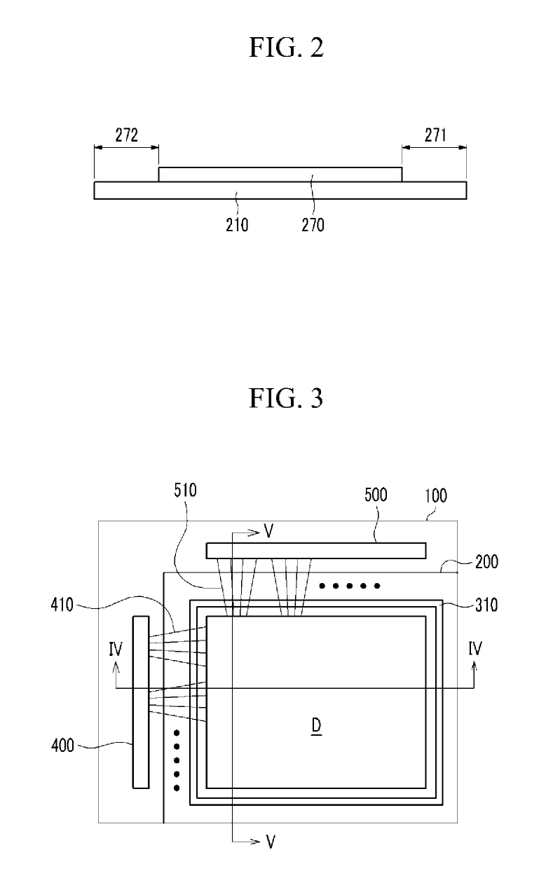

FIG. 1 is a top plan view of a mother glass for a common electrode panel according to an exemplary embodiment, and FIG. 2 is a cross-sectional view taken along the line II-II of FIG. 1.

As shown in FIG. 1 and FIG. 2, a mother glass 2000 for a common electrode panel includes six 6 common electrode panels 200A, 200B, 200C, 200D, 200E, and 200F. Also, the number of the common electrode panels may be more than six.

The mother glass 2000 includes a substrate 210 and a common electrode 270 formed on the substrate 210. A plurality of thin films may be formed between the substrate 210 and the common electrode 270, and on the common electrode 270. Also, the common electrode 270 includes a first cutout 271 and a second cutout 272. The first cutout 271 and the second cutout 272 are formed by removing a portion of the common electrode 270 through laser trimming.

The first cutout 271 is formed in a transverse direction with respect to the common electrode panels 200A, 200B, 200C, 200D, 200E, and 200F, and the second cutout 272 is formed in a longitudinal direction with respect to the common electrode panels 200A, 200B, 200C, 200D, 200E, and 200F.

These first cutout 271 and second cutout 272 are formed on the edge of the common electrode panels 200A, 200B, 200C, 200D, 200E, and 200F, and when cutting the common electrode panels 200A, 200B, 200C, 200D, 200E, and 200F from the mother glass 2000, they prevent the electrodes from being exposed to the outside such that the generation of corrosion due to material contamination and moisture may be prevented.

The portion of the common electrode 270 is removed through the laser trimming such that the corrosion of the common electrode may be prevented without the addition of a photolithography process of the common electrode in the twisted nematic mode, vertical alignment mode, and photo-alignment mode liquid crystal displays.

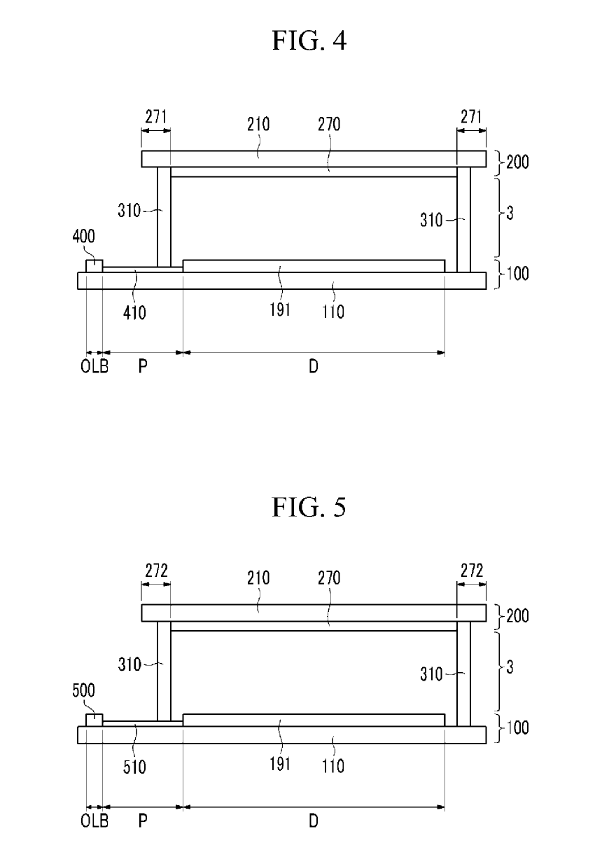

FIG. 3 is a top plan view of a liquid crystal display according to an exemplary embodiment, FIG. 4 is a cross-sectional view taken along the line IV-IV of FIG. 3, and FIG. 5 is a cross-sectional view taken along the line V-V of FIG. 3.

As shown in FIG. 3 to FIG. 5, a liquid crystal display according to an exemplary embodiment includes a thin film transistor array panel 100 and a common electrode panel 200 facing each other, and a liquid crystal layer 3 interposed between two display panels 100 and 200. The thin film transistor array panel 100 and the common electrode panel 200 are attached together by a sealant 310, and the liquid crystal layer 3 is blocked from the outside by the sealant 310 and fills the space between the two panels 100 and 200.

The thin film transistor array panel 100 is divided into a display area D displaying images, an outer lead bonding (OLB) region formed with a gate driving circuit 400 and a data driving circuit 500 supplying signals applied to the display area D, and a fan-out region P between the display area D and the OLB region. Here, the OLB region is referred to as a peripheral area.

The display area D is formed with a thin film layer 191 including a thin film transistor, pixel electrode on the substrate 110, and the fan-out region P is formed with a plurality of wires 410 and 510 to connect the gate driving circuit 400 and the data driving circuit 500 to the display area D.

The common electrode panel 200 facing the thin film transistor array panel 100 includes a substrate 210 and a common electrode 270 formed on the substrate 210. A plurality of thin films may be included between the substrate 210 and the common electrode 270 and on the common electrode 270.

The common electrode 270 in the liquid crystal display according to an exemplary embodiment includes the first cutout 271 and the second cutout 272. The first cutout 271 is formed in the transverse direction with respect to the common electrode panel 200, and the second cutout 272 is formed in the longitudinal direction with respect to the common electrode panel 200.

The first cutout 271 and the second cutout 272 are positioned on the edge of the common electrode panel 200, and portions of the first cutout 271 and the second cutout 272 are positioned at the portion corresponding to the fan-out region P.

Accordingly, the common electrode 270 is positioned only inside the sealant 310 and is not exposed to the outside. Accordingly, the corrosion due to the material contamination and the moisture is prevented.

While subject matter has been described in connection with what is presently considered to be practical exemplary embodiments, it is to be understood that it is not limited to the disclosed embodiments, but, on the contrary, is intended to cover various modifications and equivalent arrangements included within the spirit and scope of the appended claims.

What is claimed is:

1. A method of manufacturing a liquid crystal display, comprising:
forming a thin film transistor array panel including a fan-out region connecting a display area and a peripheral area;
forming a common electrode on a substrate;
forming a cutout in the common electrode by using a laser;
forming a common electrode panel by cutting the substrate; and
assembling the thin film transistor array panel and the common electrode panel,
wherein the cutout is formed on the edge of the common electrode panel and a portion of the cutout is positioned on the portion corresponding to the fan-out region.

2. The method of claim 1, wherein
the cutout includes a first cutout and a second cutout,
the first cutout is formed in a transverse direction with respect to the common electrode panel, and
the second cutout is formed in a longitudinal direction with respect to the common electrode panel.

3. The method of claim 2, wherein
the assembling of the thin film transistor array panel and the common electrode panel uses a sealant.

4. The method of claim 3, wherein
the sealant is positioned at the first cutout, the second cutout, and the fan-out region.

5. The method of claim 4, further comprising,
before the assembling of the thin film transistor array panel and the common electrode panel,
forming a liquid crystal layer between the thin film transistor array panel and the common electrode panel.

6. The method of claim 1, wherein
the assembling of the thin film transistor array panel and the common electrode panel uses a sealant.

7. The method of claim 6, wherein
the sealant is positioned at the cutout and the fan-out region.

8. The method of claim 7, further comprising,
before the assembling of the thin film transistor array panel and the common electrode panel,
forming a liquid crystal layer between the thin film transistor array panel and the common electrode panel.

9. The method of claim 1, wherein
the display area is formed with a plurality of thin films.

10. The method of claim 1, wherein
the peripheral area is formed with a gate driving circuit and a data driving circuit.

11. The method of claim 10, wherein
the fan-out region is formed with a plurality of wires connecting the gate driving circuit and the data driving circuit to the display area.

12. A liquid crystal display device having a display area for displaying an image, the display device comprising:
a common electrode disposed entirely within a sealed space that defines the display area of the liquid crystal display device.

13. The liquid crystal display device of claim 12, further including opposite substrates and liquid crystal molecules disposed therebetween that further define the sealed space.

14. The liquid crystal display device of claim 13, wherein the opposite substrates are a common electrode panel having the common electrode formed thereon and a thin film array panel.

15. A method of manufacturing a liquid crystal display device having a display area for displaying an image, the method comprising;
disposing a common electrode entirely within a sealed space that defines the display area of the liquid crystal display device.

16. The method of claim 15, further comprising:
forming opposite substrates; and
disposing liquid crystal molecules therebetween that further define the sealed space.

17. The method of claim 16, wherein the opposite substrates are a common electrode panel having the common electrode formed thereon and a thin film array panel.
